(19) United States
(12) Patent Application Publication
(10) Pub. No.: US 2002/0174351 A1
(43) Pub. Date: Nov. 21, 2002

(54) High security host adapter

(75) Inventors: Jachoon Jeong, Seoul (KR); Pyeonghan Lee, Gyonggi-do (KR); Jeahong Eom, Seoul (KR); Hunkyu Choi, Gyonggi-do (KR); Eugene Chu, Cupertino, CA (US); Marty Hwang, Santa Clara, CA (US); Joseph Kim, Santa Clara, CA (US)

Correspondence Address: GREENBLUM & BERNSTEIN, P.L.C., 1941 ROLAND CLARKE PLACE, RESTON, VA, 20191, US

(73) Assignee: ARALION INC, Seoul (KR)

(21) Appl. No.: 09/983,485

(22) Filed: Oct. 24, 2001

(30) Foreign Application Priority Data
May 18, 2001 (KR) 2001-27242

(51) Int. Cl. H04L 9/00

(52) U.S. Cl. 713/189; 713/168

(57) ABSTRACT

A host adapter connected between first and second buses, the first bus connected to a system memory or a central processing unit (CPU), the second bus connected to a storage apparatus. The host adapter includes first and second encryption/decryption processors and a first-in-first-out (FIFO) buffer. The first encryption/decryption processor is connected to the first type bus, and deciphers a data input through the first bus and enciphers a deciphered data by a second encryption/decryption processor using a first secret key. The second encryption/decryption processor is connected to the second bus, and enciphers the deciphered data from the first encryption/decryption processor and deciphers a data input through the second bus using a second secret key. The first-in-first-out (FIFO) buffer is connected between the first and second encryption/decryption processor and buffers the enciphered/deciphered data of the first and second encryption/decryption processors.

### BACKGROUND OF THE INVENTION

2. Field of the Invention

The present invention relates to a high security host adapter connected data between different types of buses.

2. Description of Related Art

As an Internet is widely spread, a personal computer and a personal computer, a personal computer and a workstation, etc., are connected through a network such as an extranet, an intranet, a virtual private network (VPN), and so on.

Such a network is exposed to the public, and thus a hacking of secret information of a company occurs frequently, damaging the company incredibly. Therefore, respective companies employ high-security network equipment to inhibit a hacking. The high security network equipment is high in cost and also requires a high maintenance fee and a high skilled person.

Also, a storage system for use in computer which stores, for example, industrial information of a company is generally connected directly to a network, and thus there exists a dangerousness of information leak.

Meanwhile, a cryptographic algorithm to prevent a hacking of an information is classified into the two types. One is an asymmetric cryptosystem or a public key infrastructure (PKI) system. The asymmetric cryptosystem is one which performs an encryption and a decipherment using different keys (i.e., private key and public key). A typical algorithm of the PKI is a rivest, shamir, adleman (RSA) cryptosystem which is widely used in a peer to peer communication.

The other is a symmetric cryptosystem. The symmetric cryptosystem is one which perform an encryption and a decipherment using a single key. A typical algorithm is a data encryption standard (DES). Since the symmetric cryptosystem use a single key for an encryption and a decipherment, the key has to be transferred together with enciphered document or information to a receiver for the sake of a decipherment.

The cryptographic algorithm is very important and thus is embodied in the form of a hardware. Such a cryptographic algorithm is difficult to be compatible when different algorithm is applied because different algorithms differ in methods of analyzing a key. In addition, a compatibility with a communication equipment of an internet service provider (ISP) contacting a plurality of computers should be considered. Even though compatibility is secured, there occur frequently cases that a secret is leaked between terminals and a gateway.

### SUMMARY OF THE INVENTION

To overcome the problems described above, preferred embodiments of the present invention provide a host adapter having a high security and a high processing speed.

It is another object of the present invention to provide a host adapter which is inexpensive.

In order to achieve the above object, the preferred embodiments of the present invention provide a host adapter connected between first and second buses. The first bus is connected to a system memory or a central processing unit (CPU), and the second bus is connected to a storage apparatus. The host adapter includes first and second encryption/decryption processors and a first-in-first-out (FIFO) buffer. The first encryption/decryption processor is connected to the first type bus, and deciphers a data input through the first bus and enciphers a deciphered data by a second encryption/decryption processor using a first secret key. The second encryption/decryption processor is connected to the second bus, and enciphers the deciphered data from the first encryption/decryption processor and deciphers a data input through the second bus using a second secret key. The first-in-first-out (FIFO) buffer is connected between the first and second encryption/decryption processor and buffers the enciphered/deciphered data of the first and second encryption/decryption processors.

The host adapter further includes an encryption/decryption controller determining an encryption operation and a decryption operation of the first and second encryption/decryption processor and providing the second and second secret keys to drive the first and second encryption/decryption processors.

The host adapter further includes a first bus interface, a second bus interface and a ROM BIOS. The first bus interface is connected between the first bus and the first encryption/decryption processor and interfaces a data of the first bus with the system memory or the CPU. The second bus interface is connected between the second bus and the second encryption/decryption processor and interfaces a data of the second bus with the storage apparatus. The ROM BIOS stores the first and second secret keys and a program to control the host adapter. The first secret key is provided by a user, and the second secret key is provided by a data owner.

The encryption/decryption controller includes a secret key controller and first and second encryption/decryption processor drivers. The secret key controller determines whether to encipher/decipher the data of the first and second encryption/decryption processor or not through a user authentication and provides the first and second secret keys to the first and second encryption/decryption processors. The first encryption/decryption processor driver enables and drives the first encryption/decryption processor by control signals generated from the secret key controller, and provides the first encryption/decryption processor with the first secret key. The second encryption/decryption processor driver enables and drives the second encryption/decryption processor by the control signals generated from the secret key controller, and provides the second encryption/decryption processor with the second secret key.

The first and second encryption/decryption processors are a triple data encryption system (3-DES) module. The first and second buses are a PCI bus, a IDE bus, a SCSI bus, a USB bus, Firewire, or a RS232 bus, respectively.

The present invention has the following advantages. It is prevented that an information is leaked, thereby securing a high security. Also, even though a hacking of an information occurs, if a hacker does not know a secret key, the information cannot be deciphered. Besides, since the host adapter includes two encryption/decryption modules (i.e., encryption/decryption processors) and one register (i.e., FIFO buffer) and thus does not occupy a main bus of a computer, whereby improving a data processing speed. The high security host adapter can substitute the high-cost high security network equipment.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIG. 1 is a block diagram illustrating a host adapter according to the present invention; and

FIG. 2 is a flow chart illustrating operation of reading an information stored in a hard disk through the host adapter of FIG. 1; and

FIG. 3 is a flow chart illustrating operation of storing an information in the hard disk through the host adapter of FIG. 1.

### DETAILED DESCRIPTION OF PREFERRED EMBODIMENTS

Reference will now be made in detail to preferred embodiments of the present invention, example of which is illustrated in the accompanying drawings.

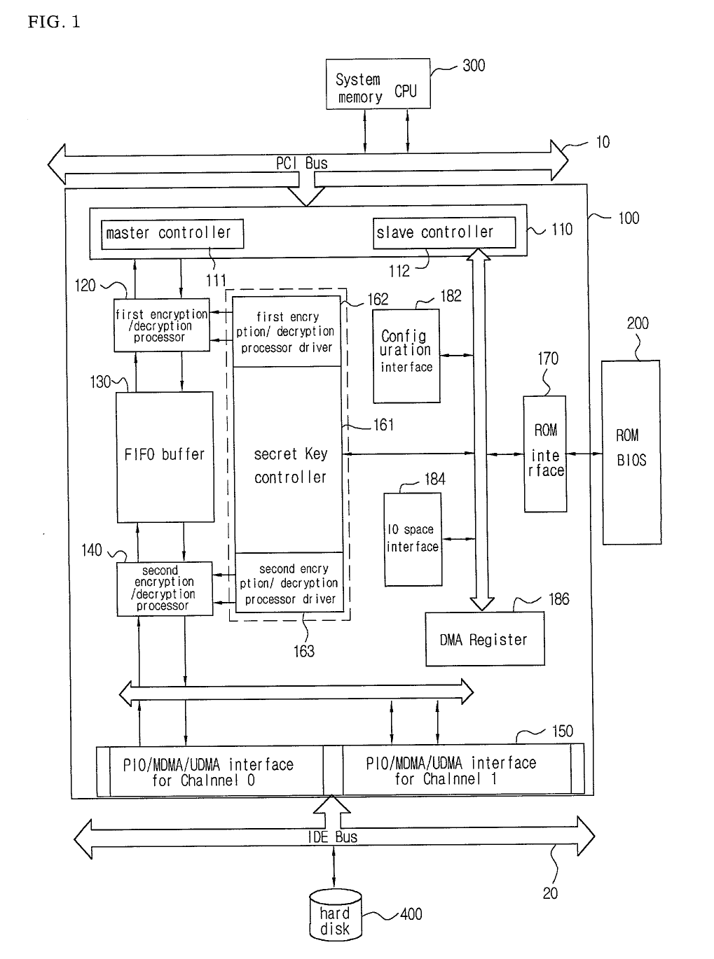

FIG. 1 is a block diagram illustrating a host adapter according to the present invention. The host adapter 100 is connected to a ROM BIOS 200.

The host adapter 100 enciphers and deciphers a data between different types of buses 10 and 20 (e.g., PCI bus and IDE bus) using secret keys. The ROM BIOS 200 stores a program for controlling an operation of the host adapter, and also stores secret key data of registered users and a secret key data of an information owner (i.e., computer owner). The host adapter 100 uses a redundant array of independent disks (RAID) controller of an AT attachment packet interface (ATAPI) method.

The host adapter 100 of FIG. 1 includes a PCI bus interface 110, a first encryption/decryption processor 120, a first-in-first-out (FIFO) buffer 130, a second encryption/decryption processor 140, an IDE bus interface 150, an encryption/decryption controller 160, and a ROM interface 170.

The PCI bus interface 110 includes a master controller 111 and a slave controller 112, and interfaces a data of a PCI bus 10 with a system memory or central processing unit (CPU) 300. Every information applied to the PCI bus 10 get into the host adapter 100. The first encryption/decryption processor 120 enciphers and deciphers an IO data of the PCI bus interface 110 using a secret key of a user (hereinafter referred to as “first secret key”). The FIFO buffer 130 buffers enciphered or deciphered information of the first and second encryption/decryption processors 120 and 140. The second encryption/decryption processor 140 enciphers the deciphered data transferred from he first encryption/decryption processor 120 or deciphers the enciphered data stored in a hard disk (i.e., storage apparatus) 400 using a secret key of an information owner (hereinafter referred to as “second secret key”). The first and second encryption/decryption processors 120 and 140 are composed of a triple data encryption system (3-DES) module. The IDE bus interface 150 interfaces an IDE bus 20 connected to the hard disk with the second encryption/decryption processor 140.

The encryption/decryption controller 160 includes a secret key controller 161, a first encryption/decryption processor driver 162, a second encryption/decryption processor driver 163. The secret key controller 161 determines whether to encipher or decipher an information input currently in the first and second encryption/decryption processors 120 and 140, and provides the first and second secret keys to the first and second encryption/decryption processor drivers 162 and 163, respectively. The first and second encryption/decryption processor drivers 162 and 163 enable the first and second encryption/decryption processors 120 and 140 by control signals generated when a user request to read or store an information. At the same time, the first and second encryption/decryption processor drivers 162 and 163 provide the first and second encryption/decryption processors 120 and 140 with the first and second secret keys, respectively.

The ROM interface 170 transfers the first and second secret keys from the ROM BIOS 200 to the encryption/decryption controller 160 through the ROM interface 170.

The host adapter 100 further includes a PCI configuration interface 182, an 10 space interface 184, and a direct memory access (DMA) register 186.

The PCI configuration interface 182 receives a PCI configuration information through the slave controller 110 to set a PCI configuration to control the PCI bus 10 and stores the PCI configuration so that a host can access it. The IO space interface 184 receives or outputs information applied to the PCI bus 10 through slave controller 112. The direct memory access (DMA) register 186 receives various parameters required for a DMA operation and stores them.

Even though just the PCI bus and the IDE bus are described in FIG. 1, other buses such as a SCSI bus, a USB bus, Firewire, a RS232 bus, etc., can be applied to the present invention.

The host adapter 100 reads an information from the hard disk 20 as follows: an enciphered information stored in the hard disk 400 is deciphered using the second secret key, and the deciphered information is enciphered again using the first secret key.

The host adapter 100 stores an information in the hard disk 400 as follows: an enciphered information transferred from a user is deciphered using the first secret key, and the deciphered information is enciphered again using the second secret key.

In greater detail, when a user access an information stored in the hard disk 400, the second encryption/decryption processor 140 deciphers the enciphered information using the second secret key provided by the second encryption/decryption processor driver 163. The deciphered information is enciphered by the first encryption/decryption processor 120 using the first secret key provided by the first encryption/decryption processor driver 162, and thereafter the enciphered information is provided to the user through the PCI interface 110.

When a user stores an information in the hard disk 400, the first encryption/decryption processor 120 deciphers the enciphered information transferred externally using the first secret key provided by the first encryption/decryption processor driver 162. The deciphered information is enciphered by the second encryption/decryption processor 140 using the second secret key provided by the second encryption/decryption processor driver 163. The enciphered information is stored in the hard disk 400 through the IDE interface 140.

An information getting into the host adapter 100 is stored by several channels. One is a process input output (PIO) mode which an information is transferred in order of the slave controller 112, the IO space interface 184 and an IDE channel. This is a method which a host CPU transfers the information directly without using a DMA controller. The others are a multi work direct memory access (MDMA) mode and an ultra direct memory access (UDMA) mode. Parameters required for a DMA operation, as described above, are transferred from a host through the slave controller 112 and stored in the DMA register 186. Such access methods are stored in the secret key controller 161.

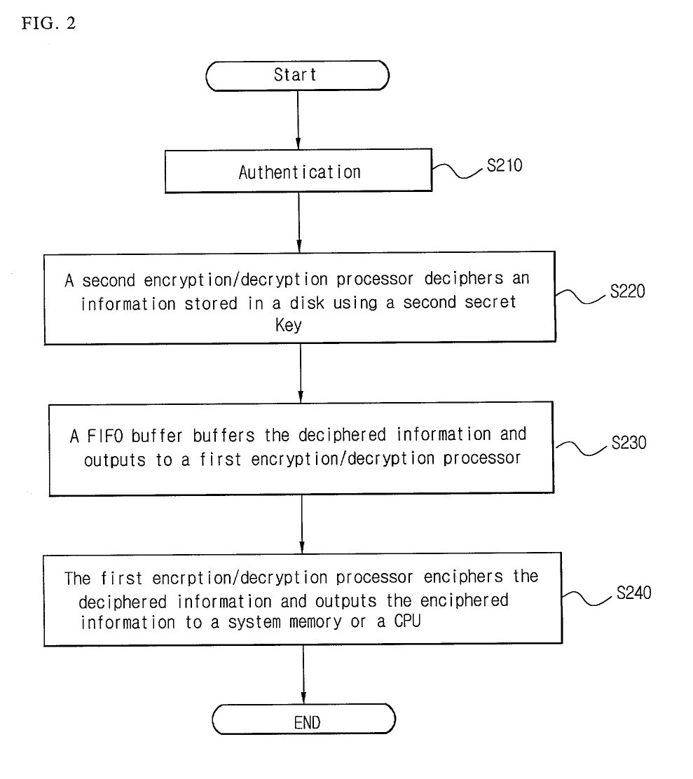

FIG. 2 is a flow chart illustrating operation of reading an information stored in the hard disk 400 through the host adapter 100 according to the present invention.

First, a user has to be authenticated in order to read an information stored in the hard disk 400 (step S210).

An authentication can be performed by various methods. For example, in order to be authenticated, a user can input his ID and password.

When the user is authenticated, the first and second secret keys stored in the ROM BIOS 200 are transferred to the secret key controller 160 through the ROM interface 170.

When the user requests to read a desired information, encryption/decryption control signals are transferred to the secret key controller 161 through the slave controller 112.

The first and second encryption/decryption processor drivers 162 and 163 enable and drive the first and second encryption/decryption processors 120 and 130, respectively, according to the encryption/decryption control signals. Also, The first and second encryption/decryption processor drivers 162 and 163 provide the first and second encryption/decryption processors 120 and 140 with the first and second secret keys, respectively.

When a read command is transferred to the hard disk 400 through the slave controller 112, the enciphered information stored in the hard disk 400 is transmitted to the second encryption/decryption processor 140 through the IDE interface 140 or the 10 space interface 184.

The second encryption/decryption processor 140 deciphers the enciphered information using the second secret key and inputs the deciphered information to the FIFO buffer 130 (step 220). The FIFO buffer 130 buffers the deciphered information and transmits it to the first encryption/decryption processor 120 (step S230).

The first encryption/decryption processor 120 enciphers the deciphered information using the first secret key and transfers it the system memory or CPU 300 through the PCI bus interface 100 (step S240).

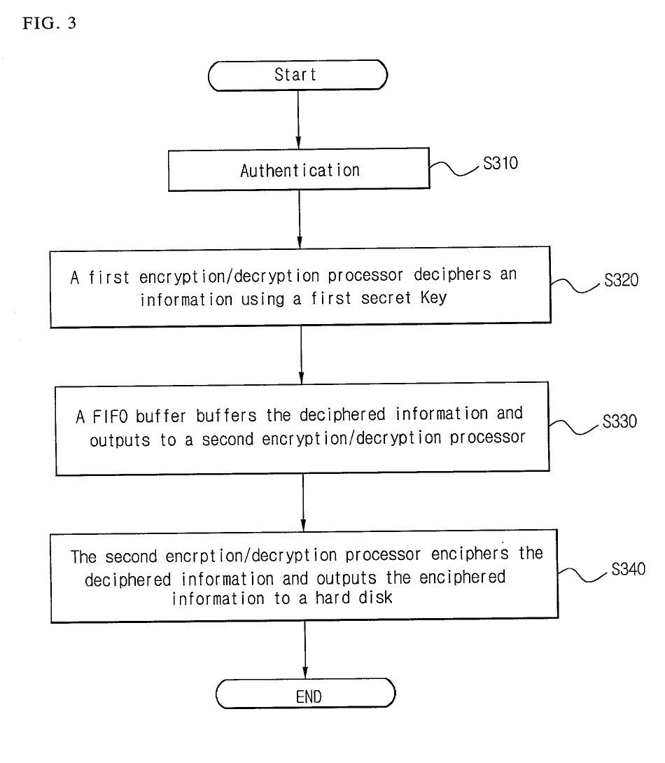

FIG. 3 is a flow chart illustrating operation of storing an information in the hard disk 400 through the host adapter 100 according to the present invention.

First, a user has to be authenticated by the method described above in order to store an information in the hard disk 400 (step 310).

When the user is authenticated, the first and second secret keys stored in the ROM BIOS 200 are transferred to the secret key controller 160 through the ROM interface 170.

When the user requests to store a desired information, a encryption/decryption control signals are transferred to the secret key controller 161 through the slave controller 112.

The first and second encryption/decryption processor drivers 162 and 163 enable and drive the first and second encryption/decryption processors 120 and 130, respectively, according to the encryption/decryption control signals. Also, The first and second encryption/decryption processor drivers 162 and 163 provide the first and second encryption/decryption processors 120 and 140 with the first and second secret keys, respectively.

An enciphered information is transferred to the first encryption/decryption processor 120 through the master controller 111. The first encryption/decryption processor 120 deciphers the enciphered information using the first secret key and inputs the deciphered information to the FIFO buffer 130 (step 320). The FIFO buffer 130 buffers the deciphered information and transmits it to the second encryption/decryption processor 140 (step S330).

The second encryption/decryption processor 140 enciphers the deciphered information using the second secret key, and transfers and stores the enciphered information in the hard disk 400 through the IDE bus interface 150 (step S340).

As described herein before, using the host adapter according to the present invention, it is prevented that an information is leaked, thereby securing a high security. Also, even though a hacking of an information occurs, if a hacker does not know a secret key, the information cannot be deciphered. Besides, since the host adapter includes two encryption/decryption modules (i.e., encryption/decryption processors) and one register (i.e., FIFO buffer) and thus does not occupy a main bus of a computer, whereby improving a data processing speed. The high security host adapter can substitute the high-cost high security network equipment.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A host adapter connected between first and second buses, the first bus connected to a system memory or a central processing unit (CPU), the second bus connected to a storage apparatus, the adapter comprising:
a first encryption/decryption processor connected to the first type bus, and deciphering a data input through the first bus and enciphering a deciphered data by a second encryption/decryption processor using a first secret key;
the second encryption/decryption processor connected to the second bus, and enciphering the deciphered data from the first encryption/decryption processor and deciphering a data input through the second bus using a second secret key; and
a first-in-first-out (FIFO) buffer connected between the first and second encryption/decryption processor and buffering the enciphered/deciphered data of the first and second encryption/decryption processors.

2. The adapter of claim 1, further comprising, an encryption/decryption controller determining an encryption operation and a decryption operation of the first and second encryption/decryption processor and providing the second and second secret keys to drive the first and second encryption/decryption processors.

3. The adapter of claim 2, further comprising,
a first bus interface connected between the first bus and the first encryption/decryption processor and interfacing a data of the first bus with the system memory or the CPU;
a second bus interface connected between the second bus and the second encryption/decryption processor and interfacing a data of the second bus with the storage apparatus; and
a ROM BIOS storing the first and second secret keys and a program to control the host adapter, the first secret key is provided by a user, the second secret key is provided by a data owner.

4. The adapter of claim 3, wherein the encryption/decryption controller includes
a secret key controller determining whether to encipher/decipher the data of the first and second encryption/decryption processor or not through a user authentication and providing the first and second secret keys to the first and second encryption/decryption processors;
a first encryption/decryption processor driver enabling and driving the first encryption/decryption processor by control signals generated from the secret key controller, and providing the first encryption/decryption processor with the first secret key; and
a second encryption/decryption processor driver enabling and driving the second encryption/decryption processor by the control signals generated from the secret key controller, and providing the second encryption/decryption processor with the second secret key.

5. The adapter of claim 1, wherein the first and second encryption/decryption processors are a triple data encryption system (3-DES) module.

6. The adapter of claim 1, wherein the first and second buses are a PCI bus, a IDE bus, a SCSI bus, a USB bus, Firewire, or a RS232 bus, respectively.
